(19) United States
(12) Patent Application Publication
(10) Pub. No.: US 2008/0075229 A1
(43) Pub. Date: Mar. 27, 2008

(54) Generation of Monochromatic and Collimated X-Ray Beams

(75) Inventor: Thomas W. Ryan, Bend, OR (US)

Correspondence Address: Silicon Valley Patent Group LLP, 18805 Cox Avenue, Suite 220, Saratoga, CA, 95070, US

(73) Assignee: NANOMETRICS INCORPORATED, Milpitas, CA (US)

(21) Appl. No.: 11/862,537

(22) Filed: Sep. 27, 2007

Related U.S. Application Data
(60) Provisional application No. 60/848,341, filed on Sep. 27, 2006.

(51) Int. Cl. H01J 35/08; H01J 35/12; H01J 35/14

(52) U.S. Cl. 378/70; 378/121; 378/134; 378/137; 378/142

(57) ABSTRACT

A compact x-ray source includes an electron beam source with a metallic film on a diamond window. The metallic film, which may be copper or scandium, absorbs the electron beams and produces k-alpha x-rays. The diamond window is a single crystal of diamond with a crystallographic orientation to diffract the x-rays, thereby producing a monochromatic and well collimated x-ray beam. The orientation of the crystal lattice may be configured to produce multiple x-ray beams. A plurality of electron beam sources may also be used to generate multiple x-ray beams. A detector is used to receive the x-ray beam after it interacts with a sample to be measured.

### CROSS-REFERENCE TO RELATED APPLICATIONS

This application claims the benefit of U.S. Provisional Application No. 60/848,341, filed Sep. 27, 2006, entitled “System for Generating Monochromatic and Collimated X-Ray Beams”, the entirety of which is incorporated herein by reference.

### FIELD OF THE INVENTION

The present invention relates to an x-ray system and more particularly to an x-ray system that produces monochromatic and well collimated x-rays.

### BACKGROUND

Conventional x-ray systems, e.g., used for x-ray diffraction, typically include a water-cooled x-ray source as well as collimation and/or monochromation elements. The resulting devices are generally physically large and massive. While it is desirable to place the x-ray system close to the sample due to intensity attrition, which are functions of the inverse square law and air absorption, contact between the x-ray system and the sample, particularly delicate semiconductor wafers, must be avoided. The large size of conventional x-ray systems, however, limit how close the x-ray system may be placed to the sample.

Accordingly, an improved x-ray system that is more compact is desired. Such an x-ray system may be used in many applications, including but not limited to high resolution x-ray diffraction measurements on small areas.

### SUMMARY

A compact x-ray source that produces monochromatic and a well collimated x-ray beam, in accordance with an embodiment of the present invention, includes an electron beam source, along with a metallic film on a diamond window. The metallic film, which serves as the anode, may be copper or scandium, and absorbs the electron beams and produces k-alpha x-rays. The diamond window is a single crystal of diamond with a crystallographic orientation to diffract the x-rays, thereby producing a monochromatic and well collimated x-ray beam. Thus, the system is compact and integrated. If desired, orientations of the crystal lattice may be configured to produce multiple x-ray beams. Further, a plurality of electron beam sources may also be used to generate multiple x-ray beams. A detector is used to receive the x-ray beam after it interacts with a sample to be measured. The diamond window may serve as a window to a housing that surrounds or partially surrounds the electron beam source. Additionally, an electron beam lens assembly may be used to vary the shape and position of the electron beam, which alters the size and position of the x-ray beam.

### BRIEF DESCRIPTION OF THE DRAWINGS

FIG. 1 is a schematic illustration of an x-ray system for generating monochromatic and collimated x-ray beams, in accordance with one embodiment of the invention.

FIG. 2 is a schematic illustration of another x-ray system that uses a plurality of electron beam sources to generate a plurality of generating x-ray beams, in accordance with another embodiment of the invention.

FIG. 3 is a schematic illustration of another x-ray system with an electron beam lens assembly to vary the shape and position of the electron beam, which alters the size and position of the x-ray beam.

FIG. 4 is a schematic illustration of an x-ray diffraction system for generating and detecting x-ray beams in accordance with another embodiment of the invention.

FIG. 5 is a schematic illustration of an x-ray system for generating multiple x-ray beams by the crystallographic orientation of the diamond window.

FIG. 6 schematically illustrates multiple sets of monochromatic, collimated x-ray beams that can be generated.

### DETAILED DESCRIPTION

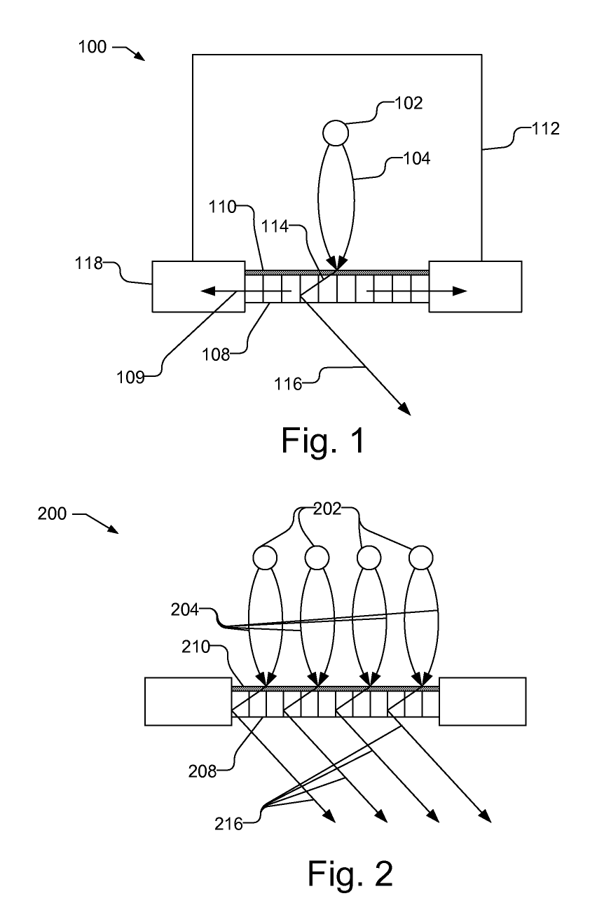

FIG. 1 is a schematic illustration of a system 100 for generating x-ray beams in accordance with one embodiment of the invention. The system 100 includes an electron beam source 102 (e.g., an electron gun) for producing an electron beam 104 along a path, a single crystal diamond 108 positioned in the path of the electron beam 104, and a copper film 110, or other type of conductive film, on the surface of the diamond 108. A commercially available single crystal diamond film may be used, with the copper film deposited by, e.g., sputtering, or other appropriate means. The system 100 may also include a single casing or housing 112 that at least partially encloses the electrode beam source 102, the diamond 108, and the copper film 110. The electron beam source 102 can generate the electron beam 104 at an energy of approximately 40 kV or other suitable energies. The diamond 108 is at least generally transparent to x-ray radiation and consequently forms the window of the housing 112. The diamond has a crystallographic orientation to diffract the x-rays to produce a monochromatic and collimated x-ray beam. The thickness of the diamond window 108 can be approximately 50 microns or another suitable thickness to withstand the vacuum environment within the housing 112. The copper film 110 is approximately 10 microns or less to minimize absorption of the x-rays. The electrode beam source 102 is the cathode, and the combination of the copper film 110 serves as the anode.

In operation, the electron beam 104 is absorbed by the copper film 110, which generates k-alpha x-rays 114. The k-alpha x-rays 114 pass through the diamond window 108 and are diffracted by the [010] lattice plane of the diamond 108 through a Bragg angle of 120°. As a result, a monochromatic, collimated x-ray beam 116 (i.e., less than 3 arc seconds angular divergence) exits the diamond window 108 at an angle of 30° relative to the surface of the diamond window 108. This monochromatic, well collimated x-ray beam 116 can be used for, e.g., x-ray diffraction analysis or other suitable purposes, such as x-ray reflection, and x-ray fluorescence analysis. By way of example, the x-ray beam 116 can be used to analyze crystal structures of thin films on light emitting diodes, laser diodes, and other devices.

The lattice structure of the diamond window 108 advantageously separates different wavelengths of x-rays such that the diamond window 108 is a monochromator that is integrated within the system. Consequently, the system 100 does not require a separate monochromator to isolate a selected wavelength of the x-rays. Because the system 100 does not require a separate monochromator and because the copper film 110 is formed on the diamond window 108 and not spaced apart from the window 108, the size of the system 108 is reduced relative to conventional x-ray systems. The reduced size of the system 100 enables the system 100 to be positioned closer to a sample during analysis compared to conventional systems. The path length between the sample and the x-ray system is related to the size of the x-ray system because the path length must be sufficient to allow the sample and system to move relative to each other to properly aim the x-ray beam without the sample contacting the system. Moreover, the loss in the intensity of the x-rays corresponds to the path length. With the shorter path length of the x-ray system 100, the losses in intensity of the system 100 are reduced, which permits the system to use a reduced power source 102.

In addition to isolating specific wavelengths of x-rays, the diamond window 108 is also generally thermally conductive. Therefore, the heat generated by the electron beam 104 impinging upon the copper film 110 can be conducted away by the diamond window 108, as illustrated by arrows 109, to a heat sink 118. Moreover, the diamond window 108 is sealably attached to the housing 112 of the system and maintains a vacuum within the housing while forming the window that permits x-ray radiation to pass out of the system.

FIG. 2 is a schematic illustration of a system 200 for generating x-ray beams in accordance with another embodiment of the invention. The illustrated system is generally similar to the system 200 described above with reference to FIG. 1. However, the system 200 illustrated in FIG. 2 includes multiple electron beam sources 202 that each produce an electron beam 204. Each electron beam 204 impinges upon the copper layer 208 and diamond window 208 and generates a corresponding x-ray beam 216. This array of collimated, monochromatic x-ray beams 216 can be used for multiple, parallel x-ray diffraction measurements. A 1-dimensional array of electron sources 202 may be used to form a 1-dimensional array of x-ray beams 216 (e.g., a line of beams) or a 2-dimensional array of electron sources 202 may be used to produce a 2-dimensional array of x-ray beams 216 (e.g., an array of beams).

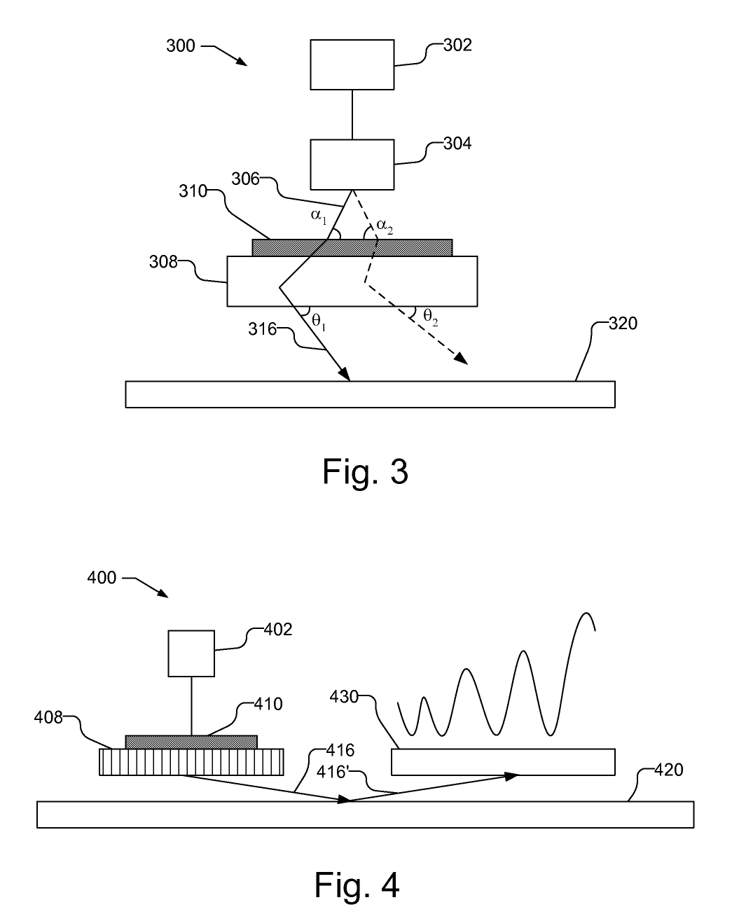

FIG. 3 is a schematic illustration of a system 300 for generating x-ray beams in accordance with another embodiment of the invention. The illustrated system is generally similar to the system 100 described above with reference to FIG. 1. The system 300 illustrated in FIG. 3, however, further includes an electron beam lens assembly 304 positioned in the beam path between the electron beam source 302 and the copper film 310 and diamond window 308. The lens assembly 304 enables the system 300 to adjust the shape and position of the electron beam, which alters the size and position of the monochromatic, collimated x-ray beam 316. Thus, the system 300 can adjust the size of the beam 316 and aim the beam 316 at a desired portion of the sample 320 and/or scan (e.g., raster scan) the beam 316 across an area of the sample without physically moving relative to the sample. For example, the lens assembly 304 can change the path of the electron beam 306 such that the beam 306 impinges upon the copper film 310 at one of a plurality of different incidence angles α. Because the exit angle θ of the monochromatic, collimated x-ray beam 316 is related to the incidence angle α, by changing the incidence angle α, the exit angle θ is also changed. As a result, the lens assembly 304 can adjust and control the exit angle θ of the monochromatic, collimated x-ray beam 316 to direct the beam toward a selected portion of the sample 320. In one application, the system 300 can use the lens assembly 304 to direct the x-ray beam 316 to a particular point of a sample. In another application, the system can be used to raster scan the x-ray beam 316 over an area of the sample to generate a 2-dimensional map of an x-ray diffraction parameter.

FIG. 4 is a schematic illustration of an x-ray diffraction system 400 for generating and detecting x-ray beams in accordance with another embodiment of the invention. The illustrated system 400 is generally similar to the system 100 described above with reference to FIG. 1. The system 400, illustrated in FIG. 4, uses an electron source 402 with a conductive film 410 on a diamond window 408. However, system 400 uses a scandium film 410 on the diamond window 408 in lieu of the copper film. In additional embodiments, chromium, cobalt, or other suitable materials may be used to form the film layer 410 on the diamond window 408 in lieu of copper and scandium. In the illustrated embodiment, the scandium film 410 has particular utility in reflectivity measurements. Specifically, the scandium k-alpha x-rays 416 can have an energy of 4 keV and a wavelength of 3.1 angstroms. Moreover, the critical angle of scandium k-alpha x-rays 416 is approximately two times larger than the copper k-alpha x-rays. The Bragg angle of diamond [111] reflection for scandium k-alpha x-rays is approximately 96°. In the illustrated embodiment, the diamond window can be oriented such that the [111] lattice planes are inclined at an angle of Bragg angle +1° to the surface of the sample 420 (e.g., wafer) so that the x-ray beam 416 exits the window 408 at an angle of approximately 1° relative to the surface of the window 408. In several applications, the system can be positioned proximate to the surface of the sample 420 so that the incidence angle of the x-ray beam 416 at the sample 420 is approximately the critical angle. This enables the system 400 to measure the reflectivity of the sample 420 by providing a relative tilt between the sample surface and the x-ray beam 416, if necessary. In additional embodiments, the system with the scandium film 410 on the diamond window 408 can be used for x-ray diffraction analysis.

The system 400 may further include a detector 430 for detecting the reflected x-ray beam 416′. The detector 430 can be one or more solid-state silicon strip detectors (e.g., drift detectors) with the active face positioned parallel to the sample surface 420. For example, commercially available strip detectors can have a pixel size of less than 50 microns and a length of 10 mm. The angle covered by the detector 430 and the angular resolution can be modified by changing the angle of incidence to the detector 430. In additional embodiments, other position-sensitive x-ray detectors can be used.

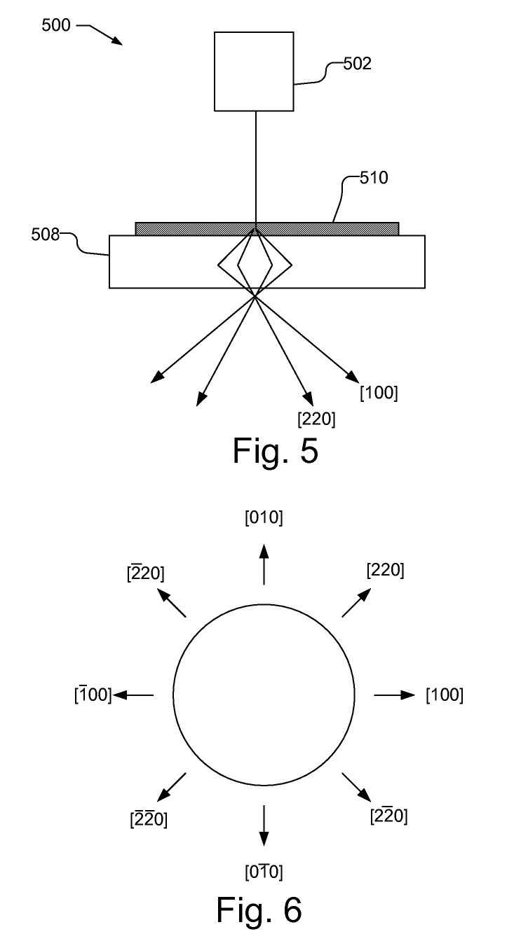

In another embodiment, the x-ray system may produce multiple monochromatic, collimated x-ray beams. FIG. 5 is a schematic illustration of an x-ray system 500 for generating multiple x-ray beams in accordance with another embodiment of the invention. The illustrated system 500 includes an electron source 502, a copper film 510 and a diamond window 508 similar to the system 100 described above with reference to FIG. 1, however, the diamond window 508 has a [001] lattice orientation. For copper k-alpha x-rays generated by a copper film on a [001] diamond window, the Bragg condition can be satisfied by multiple sets of lattice planes, thereby producing multiple monochromatic, collimated x-ray beams. For example, the 2θ angle of the [040] set of beams is 120°; and the 2θ angle of the [220] set of beams is 76°. Other sets of planes (e.g., the [311] family and the [111] family) may also produce x-ray beams. FIG. 6 schematically illustrates multiple sets of monochromatic, collimated x-ray beams that can be generated.

These multiple x-ray beams may be used to perform parallel x-ray diffraction analyses. For example, the x-ray beams may be used measure anisotropic strain in a sample. Specifically, residual stress measurements involve measuring the ‘d’ spacing of a particular crystalline phase in a polycrystalline sample from crystallites tilted at different angles relative to the surface. Many materials exhibit non-isotropic stress so the measurement may be made at a number of angles around the azimuth (i.e., an axis normal to the surface).

The multiple beam system illustrated in FIGS. 5 and 6, however, can generate a set of 8 monochromatic, collimated x-ray beams 516 at azimuthal angles of 45°. Additionally, the beams from the [040] family of planes impinge on the sample surface at an angle of 30°, while the beams from the [220] family of planes impinge on the sample surface at an angle of 53°. By using an analyzer crystal to measure the 2θ angle of a diffractive peak from the polycrystalline material of the sample, the ‘d’ spacing of a set of lattice planes may be measured (a) as a function of tilt relative to the surface of the sample, and (b) as a function of the rotation around an axis normal to the surface. Based on this information it is possible to monitor changes in anisotropic residual stress in a material. Moreover, by measuring the intensity of each of the 8 or more diffracted beams, it is possible to monitor the preferred orientation of the crystallites in the material (e.g., texture). In other embodiments, the multiple sets of monochromatic, collimated x-ray beams can be used to determine other information regarding the sample.

From the foregoing, it will be appreciated that specific embodiments of the invention have been described herein for purposes of illustration, but that various modifications may be made without deviating from the invention. Therefore, the spirit and scope of the appended claims should not be limited to the foregoing description.

What is claimed is:

1. An apparatus comprising:
a electron beam source for generating an electron beam along a beam path;
a metallic film in the beam path of the electron beam, the metallic film absorbs the electron beam and produces x rays; and
a single crystal diamond window, the metallic film is on the diamond window, wherein the diamond window is configured to diffract the x-rays into a monochromatic, collimated x-ray beam.

2. The apparatus of claim 1 further comprising a housing that at least partially contains the electron beam source and the diamond window is attached to the housing.

3. The apparatus of claim 1 further comprising a heat sink coupled to the diamond window.

4. The apparatus of claim 1, wherein the diamond window has a crystallographic orientation to produce a single x-ray beam.

5. The apparatus of claim 1, wherein the diamond window has a crystallographic orientation to produce multiple x-ray beams.

6. The apparatus of claim 1 further comprising a plurality of electron beam sources, each producing an electron beam, the metallic film absorbing each electron beam and producing multiple x-rays, and the diamond window producing a plurality of monochromatic, collimated x-ray beams.

7. The apparatus of claim 1 further comprising an electron beam lens assembly configured to vary the electron beam path to change the incident angle of the electron beam on the metallic film.

8. The apparatus of claim 1 further comprising a detector to receive the x-ray beam after interacting with a sample.

9. The apparatus of claim 1, wherein the metallic film includes at least one of copper and scandium.

10. A system for generating monochromatic, collimated x-ray beams, the system comprising:
a housing having a diamond window through which the x-ray beam is emitted;
a electron beam source positioned at least partially in the housing, the electron beam source being configured to generate an electron beam along a beam path; and
an anode for the electron beam source, the anode comprising a metallic film on the diamond window of the housing, the metallic film absorbing the electron beam and producing x-rays;
wherein the diamond window has lattice with the crystallographic orientation arranged to transmit a monochromatic, collimated x-ray beam.

11. The apparatus of claim 10 further comprising a heat sink coupled to the diamond window.

12. The apparatus of claim 10, wherein the metallic film is on one of a [001] face and a [010] face of the diamond window.

13. The apparatus of claim 10 further comprising a plurality of electron beam sources, each producing an electron beam, the metallic film absorbing each electron beam and producing multiple x-rays, and the diamond window producing a plurality of monochromatic, collimated x-ray beams.

14. The apparatus of claim 10 further comprising an electron beam lens assembly configured to vary the electron beam path to change the incident angle of the electron beam on the metallic film.

15. The apparatus of claim 10 further comprising a detector to receive the x-ray beam after interacting with a sample.

16. The apparatus of claim 10, wherein the metallic film includes at least one of copper and scandium.

17. A method comprising:
producing an electron beam;
converting the electron beam to x-rays by a metallic film on a diamond window; and
generating a monochromatic collimated x-ray beam by diffraction through the diamond window.

18. The method of claim 17, further comprising measuring a sample using the monochromatic collimated x-ray beam.

19. The method of claim 18, wherein measuring the sample comprises receiving the x-ray beam with a detector after the x-ray beam interacts with the sample.

20. The method of claim 19, wherein the x-ray beam interacts with the sample by reflection or diffraction.

21. The method of claim 17, further comprising generating a plurality of monochromatic collimated x-ray beams by diffraction through the diamond window.

22. The method of claim 17, further comprising producing a plurality of electron beams, converting each electron beam into x-rays by the metallic film; and generating a corresponding plurality of monochromatic collimated x-ray beams by diffraction through the diamond window.

23. The method of claim 17, further comprising adjusting the size and/or position of the electron beam before converting the electron beam to x-rays, wherein adjusting the size and/or position of the electron beam varies the size and/or position of the x-ray beam.

24. An apparatus comprising:
a housing having a diamond window through which the x-ray beam is emitted;
a heat sink coupled to the diamond window;
an electron beam source positioned at least partially in the housing, the electron beam source being configured to generate an electron beam along a beam path;
a metallic film on the diamond window of the housing, the metallic film including at least one of copper and scandium, the metallic film absorbing the electron beam and producing x-rays;
wherein the diamond window has lattice with the crystallographic orientation arranged to transmit a monochromatic x-ray beam with an angular divergence of less than 3 arc seconds; and
a detector positioned to receive the x-ray beam after the x-ray beam interacts with a sample.

25. The apparatus of claim 24 further comprising an electron beam lens assembly configured to vary the electron beam path to change the incident angle of the electron beam on the metallic film to alter an exit angle of the x-ray beam with respect to the diamond window.
